(19) United States
(12) Patent Application Publication
(10) Pub. No.: US 2024/0256861 A1
(43) Pub. Date: Aug. 1, 2024

(54) DETERMINING STATIONARY POINTS OF A LOSS FUNCTION USING CLIPPED AND UNBIASED GRADIENTS

(71) Applicant: DeepMind Technologies Limited, London (GB)

(72) Inventors: Marcus Hutter, London (GB); Bryn Hayeder Khalid Elesedy, Enfield (GB)

(21) Appl. No.: 18/424,545

(22) Filed: Jan. 26, 2024

Related U.S. Application Data
(60) Provisional application No. 63/441,399, filed on Jan. 26, 2023.

(51) Int. Cl. G06N 3/08

(52) U.S. Cl. CPC G06N 3/08

(57) ABSTRACT

A method of optimizing a loss function defined by one or more numerical parameters is provided. The method comprises determining initial values of the parameters, and performing a plurality of training iterations. Each training iteration except the first comprises (i) determining a gradient of the loss function associated with the parameters, (ii) obtaining a clipped value generated in a previous training iteration, (iii) additively combining the gradient and the clipped value to generate a modified gradient, (iv) processing, using a clipping function based on a threshold value, the modified gradient to generate a clipped gradient, (v) updating the value of the one or more parameters based on the clipped gradient, and (vi) storing, as the clipped value for use in a next training iteration, a difference between the modified gradient and the clipped gradient.

### CROSS-REFERENCE TO RELATED APPLICATION

This application claims priority under 35 U.S.C. 119 to Provisional Application No. 63/441,399, filed Jan. 26, 2023, which is incorporated by reference.

### BACKGROUND

This specification relates to determining, for a loss function which is a function of a one or more parameters, values for the parameter(s) which are a stationary point (e.g. a minimum) of the loss function. In particular, the parameters may be parameters defining a neural network, and the loss function may be a function indicative of how well the neural network performs a computational task.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

There are many applications of seeking the stationary points of loss functions defined by multiple parameters. This is typically performed using “gradient updates”, that is updates to one or more of the parameters by amounts which depend upon the gradients of the loss function with respect to the parameters for the current values of the parameters. Clipping gradients to reduce the size of gradient updates is a widely used technique to address a number of disadvantages of gradient updates becoming too large. One of these disadvantages, often encountered in the case of loss functions having a highly irregular loss landscape, such as loss functions describes the performance of deep neural networks, is the so-called “exploding gradients” problem, in which gradient updates generated at a certain point in the loss landscape are so large that a gradient update modifies the parameters to regions of the parameter space in which the loss landscape is very different. If this phenomenon occurs at a time when the parameters are close to a stationary point, the stationary point can be overshot by such a large amount that convergence to it fails. While clipping can address such problems, it does so in a way which leads to a bias in the updates to different parameters (e.g. the updates to some of the parameters are consistently clipped more than others), which can lead to certain stationary points not being found and/or undesirably slow convergence. This is particularly apparent in applications in which the gradient update in a given training iteration is evaluated by evaluating the loss function for each of a sample (a “batch”) of training examples in a training database, since if the batch is small the loss landscape tends to be more irregular. Furthermore, if the loss function is approximated in successive iterations using a different respective batch of training examples, the position of the stationary point may be slightly different for each batch. If updates to a certain parameter are consistently clipped to be below the amount by which the stationary point moves with respect to that parameter, convergence for that parameter may not occur.

This specification describes a system, implemented as computer programs on one or more computers in one or more locations, and a method to find a stationary point of a loss function which is a function of a one or more parameters. In general terms, it proposes, in each of number of iterations, using a clipped value from the previous iteration to modify a gradient; processing, using a clipping function, the modified gradient to generate a clipped gradient; updating the value of the parameter(s) based on the clipped gradient; and storing, as the clipped value for use in a next training iteration, a difference between the modified gradient and the clipped gradient. In this way, the clipping value, reflecting the amount by which the modified gradient was clipped by the clipping function in a given iteration, is used in the next iteration.

In an example, the one or more parameters may be the parameters of a neural network, and the loss function may be a loss function characterizing how well the neural network performs a computational task, e.g. with higher values of the loss function indicating that the computational task is performed less well. In this case, the stationary point is typically a minimum of the loss function. However, the method is applicable more generally, to finding stationary points (maxima, minima or in principle also saddle points) of any loss function. The term “loss function” is not used to imply that a minimum is necessarily desired.

The subject matter described in this specification can be implemented in particular embodiments so as to realize one or more of the following advantages. First, the system described in this specification is particularly suitable for use in a parallel computing system in which a plurality of processing units (e.g. distributed in different respective geographical locations) cooperate to perform optimization of a loss function.

Furthermore, the system can optimize a loss function (e.g. train a neural network) with rapid convergence to the stationary points of the loss function. This has been confirmed experimentally in neural network examples. It permits a reduction of the computational resources (e.g. the number of operations, and running time) required to train a neural network. Furthermore, even in complex cases, convergence to a good solution is more likely than with known training methods, resulting in neural networks which perform technical tasks more accurately, e.g. with less runtime error in performing the computational task. The system described in this specification can be particularly advantageous when the training is performed in small batch sizes. This is because the system described in this specification implements a memory effect which smooths out noise associated with small batch sizes. This makes the system also particularly suited for an online learning setting where only a small number of training data items are available at each training iteration. Furthermore, it is also advantageous that the system described in this specification can be combined with standard gradient descent optimization algorithms.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example computer system that iteratively optimizes a loss function.

FIG. 2 is a flow diagram of an example process for optimizing the loss function.

FIG. 3 shows an example distributed computing system for implementing the process of FIG. 2.

FIG. 4 illustrates an aliasing phenomenon for an example loss function.

FIG. 5 shows an example computer system that trains a neural network.

FIGS. 6 and 7 illustrate experimental results from an example of using the training system of FIG. 5 to train a first example neural network.

FIGS. 8 and 9 illustrate experimental results from an example of using the training system of FIG. 5 to train a second example neural network.

### DETAILED DESCRIPTION

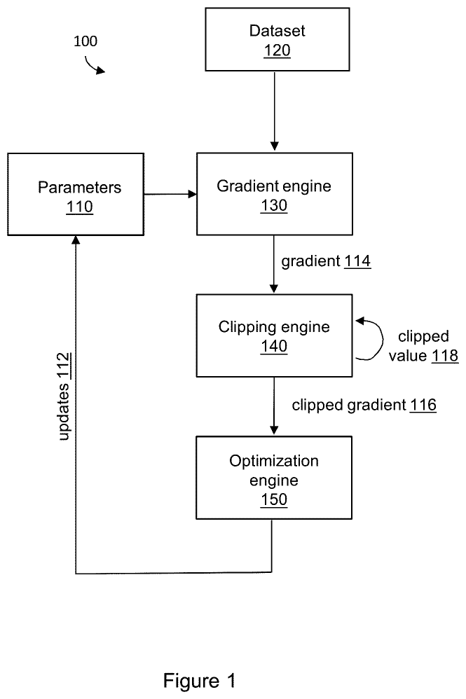

FIG. 1 shows a first example computer system 100. The computer system 100 is an example of a system, implemented as computer programs on one or more computers in one or more locations, in which the systems, components, and techniques described below are implemented. The computer system 100 implements a gradient-based optimization method (e.g. a stochastic gradient descent method) that iteratively seeks a stationary point (e.g. a maximum or minimum) of a loss function defined by one or more numerical parameters 110, referred to as “optimizing” the parameters. More specially, in each one of a plurality of iterations (or “training” iterations), the computer system 100 generates a corresponding parameter update 112 for each of the numerical parameters 110. It is to be understood that the loss function may include further numerical parameters (i.e. numerical parameters in addition to the numerical parameter(s) 110) which are not changed during the iterative optimization performed by the system 100. In the following, it is assumed, for simplicity, that the loss function is defined by more than one numerical parameter, i.e. there are a plurality of numerical parameters 110.

The computer system 100 may be used for wide range of applications including any task in which an optimization is to be performed. As one example, the parameters 110 may be the parameters of a neural network, and the loss function may be a loss function characterizing how well the neural network performs a computational task. As another example, the loss function may characterize a measure of the efficiency (e.g. the power consumption) of an item of industrial equipment (e.g. a data center or an engine) as a function of control settings of the industrial equipment (control settings of cooling equipment of the data center, or control settings of the engine). Thus, determining the minimum of the loss function corresponds to determining optimal settings which may be applied to the industrial equipment.

The computer system 100 comprises a dataset 120, a gradient engine 130, a clipping engine 140 and an optimization engine 150. The dataset 120 comprises a plurality of data items, each data item comprising values which are, or which are used with the parameters 110 to derive, the input variable(s) of the loss function.

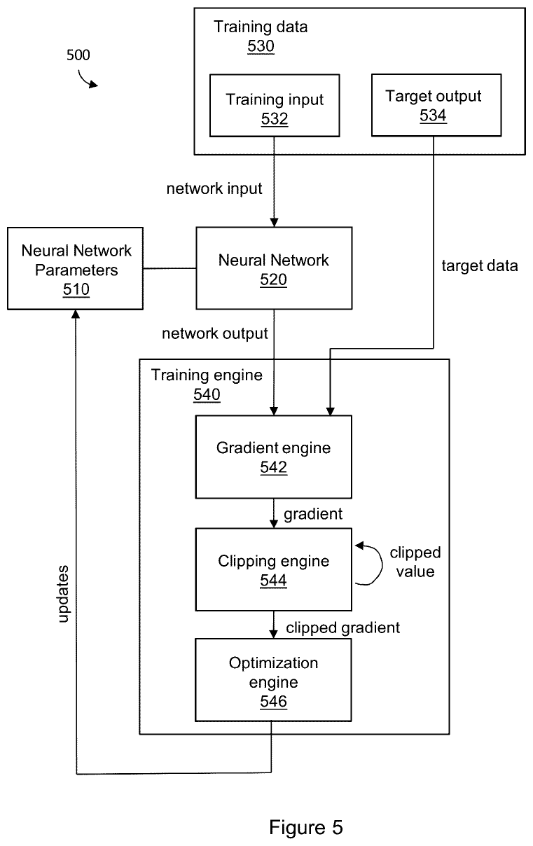

For example, in the case where the parameters 110 define a neural network, each data item may comprise a training input to the neural network and an associated target output. In this case, the loss function may receive, as one of the input variables, the output of the neural network for the training input (i.e. one or more values derived using the neural network parameters 110 with the training input, by inputting the training input to a neural network defined by the parameters 110 to generate the network output) and the associated target output (as further described below with reference to FIG. 5). The loss function may have multiple input variables derived in this way, using the parameters 100, from corresponding ones of the data items in the dataset 120. For example, the loss function may be a sum over the data items of a measure of the difference between the target output for each of the data items and the output of a neural network defined by the parameters 110 upon receiving the corresponding training input. Many types of neural network to which the present system may be applied are discussed below.

In another example, each data item may define a corresponding sample from a distribution of operating conditions for an item of industrial equipment, the parameters 110 may be design parameters for the industrial equipment, and the loss function may be a sum over the data items of an efficiency of the industrial equipment given the design parameters and the corresponding operating conditions. Minimizing the loss function thus corresponds to finding design parameters which optimize the average efficiency over the distribution of operating conditions. The design parameters, once found, may be used to manufacture an item of industrial equipment having the design parameters.

The gradient engine 130 is configured to sample one or more data items from the dataset 120 and determine, for the sampled data item(s), a gradient 114 of the loss function associated with the parameters 110. The gradient 114 (denoted g) may have a corresponding component for each of the parameters 110, e.g. g may satisfy g∈ [symbol] ^{d} where d is the number of parameters 110. The gradient 114 can be simply the differential of the loss function with respect to the respective parameter(s) evaluated at a point defined by the sampled data items, though in some gradient-based optimization methods more sophisticated gradients are calculated.

The clipping engine 140 controls the size of the gradients used to generate the parameter updates 112. More specifically, the clipping engine 140 is configured to process the gradient 114 to generate a clipped gradient 116. To this end, the clipping engine 140 obtains, for each the parameters 110, a “clipped” value 118 generated in a previous optimization iteration (e.g. by retrieving the clipped value(s) 118 from a memory of the computer system 100), and additively combines the gradient 114 and the clipped value(s) 118 to generate a modified gradient. The clipping engine 140 processes, using a clipping function, the modified gradient to generate the clipped gradient 116 (for example, but not necessarily, having reduced magnitude compared to the modified gradient).

In general, a clipping function may be defined as a function which, given at least one input parameter value (e.g. the modified gradient), modifies the at least one parameter value to be corresponding value(s) (e.g. the clipped gradient) which depend upon (e.g. are a function of) the at least one parameter value. In this process, each parameter value is modified by subtracting a respective amount: the respective “clipped value”, which is a corresponding component of a vector denoted with the symbol Δ, where Δ∈ [symbol] ^{d}. Many possibilities for the clipping function exist. In the following, the number of training iterations is denoted T, and the individual iterations are identified by a respective index t=1 . . . T. The clipping function is denoted clip(x, γₜ), where x is the input parameter value to the clipping function and γₜ is a parameter of the clipping function as described below. Thus, denoting the gradient 114 as the vector gₜ, and the modified gradient as the vector gₜ+Δₜ, the clipped gradient 116 may be denoted by a vector uₜ∈ [symbol] ^{d} given by uₜ=clip(gₜ+Δₜ, γₜ).

In one possibility, the clipping function may include checking whether the input parameter value(s) meet a magnitude criterion (for example, that the magnitudes (i.e. absolute values) of all parameter(s) are each beneath a threshold value, or respective threshold values defined for each parameter, or that some norm function of the parameters collectively is below a threshold value), and if not modifying the input parameter(s), or a proper subset of them, to reduce their magnitude (by respective clipping values), e.g. such that the criterion is met. In an implementation of this, the clipping function preserves the sign of each element of the gradient but modifies the gradient to be in a predetermined interval, e.g. [−γₜ,+γₜ] where γₜ is the threshold value (e.g. a positive threshold value). If the gradient includes multiple elements, this modification may be performed element-wise (e.g. each element is independently modified by the smallest amount (the corresponding clipping value, i.e. the corresponding component of Δ) which brings it into the interval) or as whole (such that that a norm of the gradient as a whole is within the interval). A clipping function of either kind can avoid problems associated with large gradients.

In other words, applying the clipping function to the modified gradient may comprise determining whether the modified gradient meets a magnitude criterion, and if not, generating the clipped gradient by reducing a magnitude value of the modified gradient such that the resulting clipped gradient meets the magnitude criterion. If the modified gradient meets the magnitude criterion, the modified gradient is simply provided as the clipped gradient (i.e. in this case, the clipped gradient is equal to the modified gradient).

In implementations where the gradient 114 includes multiple elements and the clipping function performs the modification element-wise, the clipping function may modify the elements of the gradient 114 such that an absolute value of each element is equal or below a threshold value. In this case the clipping function may be expressed as

$$clip ( {g}_{t} + {Δ}_{t} , {γ}_{t} ) = min ( max ( {g}_{t} + {Δ}_{t} , - {γ}_{t} ) , {γ}_{t} ) ,$$

which is to be understood element-wise. Thus, each component of the vector uₜ is in the range [−γₜ,+γₜ].

In implementations where the gradient 114 includes multiple elements, the clipping function may perform the modification such that a norm of the gradient as a whole is within the interval, Thus, each component of gₜ+Δₜ is modified by an amount which depends upon the value of other component(s) of gₜ+Δₜ. For example, the clipping engine 140 may modify the gradient 114 by calculating a Euclidean norm of the modified gradient, determining whether the Euclidean norm is larger than a threshold value, and if the Euclidean norm is determined to be larger than the threshold value, generating the clipped gradient 116 by normalizing the modified gradient such that the Euclidean norm of the clipped gradient equals the threshold value γₜ, or if the Euclidean norm is determined not to be larger than the threshold value, providing, as clipped gradient 116, the modified gradient. In this case the clipping function may be expressed as

$$clip ( {g}_{t} + {Δ}_{t} , {γ}_{t} ) = min ( 1 , \frac{{γ}_{t}}{‖ {g}_{t} + {Δ}_{t} ‖} ) * ( {g}_{t} + {Δ}_{t} ) ,$$

where ∥⋅∥ denotes the Euclidean norm.

In another possibility, the clipping function may be such as to modify the at least one parameter value (the modified gradient) to a respective value (the respective element of the clipped gradient) which has a predetermined magnitude (say γₜ) but a respective sign which is the same as the at least one parameter value. In other words, denoting the gradient by gₜ and the modified gradient by gₜ+Δₜ, the clipped gradient 116 would be given by uₜ=γₜ*sign(gₜ+Δₜ), where the sign operation is performed element-wise (i.e. for each element of gₜ+Δₜ individually). Thus, each element of uₜ∈{−γₜ,+γₜ}. A clipping function of this kind boosts small gradients and avoids the well-known “vanishing gradient problem”, as well as avoiding the large gradient problem.

In some of these implementations, the threshold value γₜ may be constant during the training. If so, it can be denoted γ. Alternatively, the clipping engine 140 may adapt the threshold value γₜ during the training. More specifically, the clipping engine 140 may select (or adapt) the threshold value γₜ during training as a function of past gradients. For example, the clipping engine 140 may adapt the threshold value γₜ based on an average value of gradients of previous iterations. In some cases, the clipping engine may 140 adapt the threshold value further based on a variance of values of the gradients of the previous iterations. In particular, in implementations where the gradient 114 includes multiple elements and the clipping function performs the modification element-wise, the clipping engine 140 may select, as a threshold value for use in a current training iteration t the threshold value γₜ according to

$${γ}_{t} = a * \hat{m} + b * \hat{s}$$

with the (fixed) parameters a, b (e.g. a, b∈ [symbol] ) and where \hat{m} and ŝ are component-wise estimates of the mean and standard-deviation of each parameter respectively. Many suitable methods of estimating the respective mean and standard-deviation of each parameter exist. As one example, the standard iterative calculation of the mean may be used together with the Welford method of estimating the variance (from which the standard-deviation can be derived as σ=\sqrt{variance}). As another example, exponentially weighted moving averages (EWMA) of the first and second moments may be used for mean and standard-deviation estimation (e.g. with a decay factor of 0.95). In this case, the estimate of the mean may be the EWMA of the first moment and the estimate of the standard-deviation may be given by σ=\sqrt{second moment}.

The clipping engine 140 also determines, for each of the parameters 110, a corresponding clipped value 118 for use in the next training iteration. The determined clipped values 118 may be stored in the memory of the computer system 100. For example, the clipping engine 140 may determine, from the modified gradient and clipped gradient 116 of the current iteration, the corresponding clipped values 118 for use in the next iteration, as Δₜ₊₁=gₜ+Δₜ−uₜ. As further described below, carrying the clipped values 118 to the next training iteration enables the system 100 to use all of the information in the gradients, which reduces the cumulative bias relative to known optimization methods that apply gradient clipping. Note that Δₜ refers to the vector of clipping values used in the t-th step, rather than the vector of clipping values derived in the t-th step, which is Δₜ₊₁. Δ₁ may be set in any way, e.g. as a vector of d zeros. In other words, in the first iteration t=1 the clipped values” are not ones retrieved from a previous iteration.

The optimization engine 150 processes the clipped gradient 116 to generate the parameter updates 112. More specifically, the optimization engine 150 may generate the parameter updates 112 from the clipped gradient 116 based on a gradient descent optimization algorithm. Any known gradient descent optimization algorithm may be used; for example, a standard stochastic gradient descent (SGD) algorithm, the “momentum” algorithm (described in Sutskever et al., “On the importance of initialization and momentum in deep learning”, International conference on machine learning, PMLR, pp. 1139-1147, 2013), the “Adam” algorithm (described in Kingma and Ba, “Adam: A method for stochastic optimization”, arXiv:1412.6980, 2014), or the like.

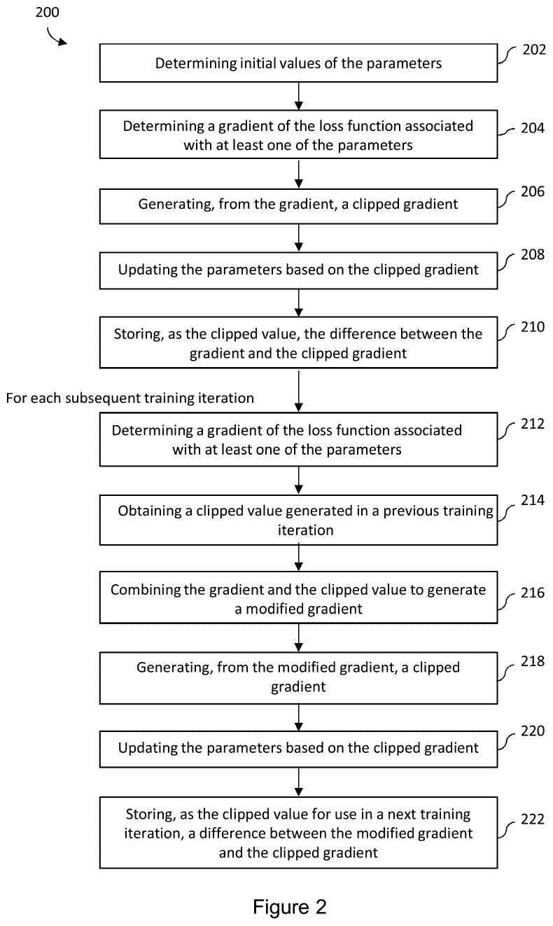

FIG. 2 is a flow diagram of an example process 200 for optimizing a loss function defined by one or more numerical parameters 110. The process of FIG. 2 can be performed by a system of one or more computers located in one or more locations, e.g. by the computer system 100 of FIG. 1. In the following, the loss function is denoted ƒ(θ,⋅) where θ denotes the numerical parameter(s) 110 and the symbol “⋅” denotes the input variable(s) of the loss function (as noted above with reference to FIG. 1, it is assumed, for simplicity, that the loss function is defined by more than one numerical parameter, i.e. a plurality of numerical parameters 110).

The process 200 starts with an initial step 202 of determining the initial values of the parameters 110. In one example, the initial values may be selected as default values or at random. In another example, the initial values may be predetermined values (e.g. obtained from a previous optimization of a similar loss function). Other ways of determining the initial values may be used.

The process 200 continues with a plurality of training iterations in which the values of the numerical parameters 110 are iteratively optimized. In general, the process 200 performs the same steps in each training iteration. However, the process 200 makes use in later iterations (t>1) of clipped values 118 from earlier iterations which are not available (or effectively equal to zero) in the first iteration (t=1). Thus, for clarity, the steps during the first training iteration are now explicitly described before describing the steps performed during subsequent iterations (i.e. for t>1).

Steps 204 to 210 are performed in a first training iteration (i.e. t=1). In step 204, a gradient gₜ₌₁ of the loss function is determined (by the gradient engine 130) based on one or more data items Zₜ₌₁ of the dataset 120 and the initial values θₜ₌₁ of the parameters 110 of the loss function. As mentioned above, in some implementations, the gradient may simply be the differential of the loss function with respect to the parameters 110, i.e.

$${g}_{t = 1} = {▽}_{θ} f ( {θ}_{t = 1} , {Z}_{t = 1} ) .$$

In step 206, the gradient gₜ₌₁ is processed (by the clipping engine 140), using the clipping function described above, to generate a clipped gradient uₜ₌₁. Thus, denoting, as above, the clipping function with clip(x, γ) (where x is the input parameter value to the clipping function and γ is the threshold value), the clipped gradient 116 of the first iteration can be expressed as uₜ₌₁=clip(gₜ₌₁, γₜ₌₁).

In step 208, the values of the parameters 110 are updated (by the optimization engine 150) based on the clipped gradient uₜ₌₁. As described above, a gradient descent optimization algorithm (e.g. a stochastic gradient descent algorithm) may be used to update the initial values θₜ₌₁ of the parameters 110 based on the clipped gradient. For example, in the case of a loss function which is to be minimized, updated values θₜ₌₂ may be generated from the initial values θₜ₌₁ to satisfy

$${θ}_{t = 2} = {θ}_{t = 1} - η {u}_{t = 1}$$

where η is a hyper-parameter determining the learning rate (e.g. η∈ [symbol] _{>0}).

In step 210, the (element-wise) difference between the gradient gₜ₌₁ and the clipped gradient uₜ₌₁ is stored as the vector of clipped values Δₜ₌₂ for use in the second iteration (that is, the clipped value is the modified gradient minus the clipped gradient, i.e. the corresponding component of Δₜ₌₂=gₜ₌₁−uₜ₌₁).

The set of steps 212 to 222 is performed for each of the subsequent training iterations (i.e. t=2 . . . T). In step 212, a gradient gₜ of the loss function is determined (by the gradient engine 130) based on a (sampled) data item Zₜ of the dataset 120 and the current values θₜ of the parameters 110 of the loss function. As before, the gradient may simply be the differential of the loss function with respect to the parameters 110, i.e.

$${g}_{t} = {▽}_{θ} f ( {θ}_{t} , {Z}_{t} ) .$$

In step 214, clipped values Δₜ generated in the preceding training iteration (t−1) for the respective parameters 110 are obtained (e.g. retrieved from the memory of the computer system 100). In step 216, the gradient gₜ and the clipped values Δₜ are additively combined to generate the modified gradient. For example, the modified gradient uₜ may be given by gₜ+Δₜ. In step 218, the modified gradient is processed, using the clipping function, to generate a clipped gradient uₜ. Thus, the clipped gradient 116 generated in iteration t can be expressed as uₜ=clip(gₜ+Δₜ, γₜ). As noted above, in some implementations, the threshold value γₜ may be constant for all training iterations (i.e. γₜ=γ). In other implementations, the threshold value γₜ may be adapted during the training iterations (e.g. γₜ≠γₜ₊₁). In these cases, the threshold value γₜ may be a function of one or more past gradients (as described above).

In step 220, the current values θₜ of the parameters 110 are updated (by the optimization engine 150) based on the clipped gradient uₜ (similar to step 208). As described above, a gradient descent optimization algorithm (e.g. a stochastic gradient descent algorithm) may be used to update the current values θₜ of the parameters 110 based on the clipped gradient uₜ. For example, in the case of a loss function which is to be minimized, updated values θₜ₊₁ may be generated from the current values θₜ to satisfy

$${θ}_{t + 1} = {θ}_{t} - η {u}_{t} .$$

In step 222 (similar to step 210), the (element-wise) difference Δₜ₊₁ between the gradient gₜ and the clipped gradient uₜ is stored as the clipped values 118 for use in the next iteration (i.e. θₜ₊₁=gₜ−uₜ). The process continues with step 212 for the next training iteration.

Controlling the size of the gradients used to generate the parameter updates can improve the training of the loss function. For example, in implementation where the one or more parameters are parameters which define a neural network, and the loss function indicates the performance of the neural network on a certain task, controlling the size of the gradients reduces the impact of noise from mini-batching (i.e. when the network is trained with a subset of the available training data in each training iteration). In contrast to conventional systems which can introduce a bias in the parameter updates (and consequently generate suboptimal network parameters) when controlling the gradient size, the process 200 can reduce or substantially prevent biased parameter updates. This is achieved by storing, in each training iteration, the clipped portion of the gradient and adding this (stored) clipped portion to the gradient generated in the next iteration (before clipping is applied). The process 200 can thereby generate clipped parameter updates which are unbiased on average and which cumulative bias is bounded by a constant. This avoids or at least mitigates problems associated with known gradient clipping techniques, leading to more rapid convergence particularly in rough loss landscapes, such as those which involve training a neural network with gradient updates based on small batch sizes.

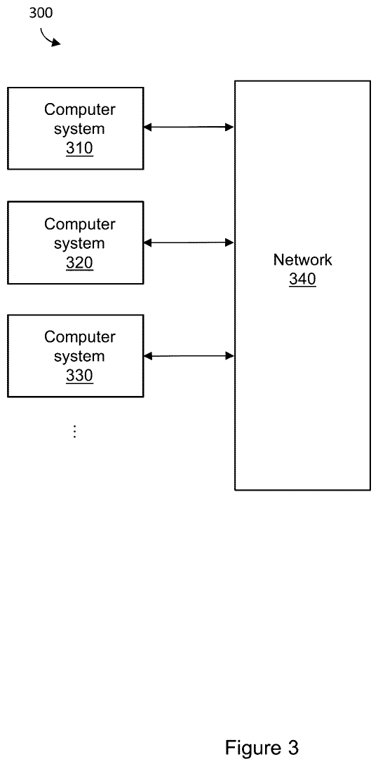

It is known for optimization problems (such as training large neural networks) to be performed in parallel by a distributed network of “worker” computer systems (e.g. computers having respective housings and/or connected via a communications network), each of which independently generates updates to a “master” set of parameters stored within one “master” computer system of the network (which may be one of the worker computer systems). The master computer system implements the updates to the master set of parameters, and may send the current master set of parameters to the (other) worker computer systems periodically. The process 200 makes possible a way of performing unbiased gradient updates to the parameters in such a distributed system, as described in the following with reference to FIG. 3 which shows a distributed computing network 300 comprising a plurality of computer systems (e.g. computer systems 310, 320, 330) which are in communication via a network 340 (e.g. the internet). The computer systems 310 may be referred to as “master” computer system and the computer systems 320 and 330 as “worker” computer systems. In one implementation, one of the computer systems of the network 300 (e.g. the master computer system 310) calculates and/or stores the clipping value(s). For example, the worker computer systems 320, 330 may perform step 212 (step 204 for the first iteration), and the master computer system 310 may perform steps 214-222 (steps 202-210 for the first iteration). In this example, the master computer system 310 may aggregate the gradients received from the worker computer systems 320, 330 before applying the clipping. This can be advantageous because while the gradient calculated by the individual worker computer systems 320, 330 may have high magnitude, the aggregated gradient may not (e.g. if the aggregation includes a normalization based on the number of computer workers), so clipping may not be required. Furthermore, intuitively, the statistics of the gradients are unaffected (because clipping has not been applied yet) until the last possible moment (i.e. just before updating the master parameters). Alternatively, the worker computer systems 320, 330 may independently calculate the modified gradients and store the clipped values. In this case, the master computer system 310 may aggregate the modified gradients received from the worker computer systems and update the master set of parameters based on the aggregated gradient. In other words, the worker computer systems 320, 330 may independently perform steps 212-218 and 220 (and optionally steps 204, 206 and 210 for the first iteration), and send the clipped gradient to the master computer system 310 following step (iv), and the master computer system 310 may aggregate the modified gradients before performing step 220 (and optionally step 208 for the first iteration). This can be advantageous because the effect of any spurious or outsized gradients on any worker computer system on the aggregate gradient is limited (e.g. if one training data item on one worker computer system is causing problems, such as generating excessively high gradients, then only the modified gradients generated by this worker computer system would be affected).

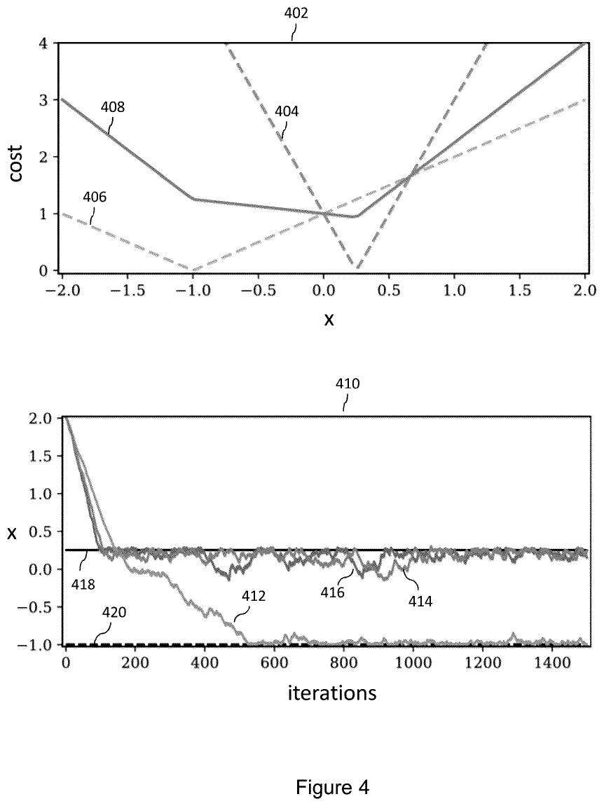

An aliasing phenomenon that can occur when gradient clipping is applied in an optimization problem is now described with reference to FIG. 4. In this example, a stochastic optimization problem is considered in which the goal is to optimize the loss function ƒ(x)= [symbol] [F(x)] where x is the parameter of the loss function (i.e. in this simple example the loss function is defined by a single numerical parameter x), [symbol] [. . . ] indicates the expected value and

$$F ( x ) = \vert 4 x - 1 \vert with a probability \frac{1}{4} , and$$

$$F ( x ) = \vert x + 1 \vert with a probability \frac{3}{4} .$$

Thus, one can determine that

$$f ( x ) = \frac{1}{4} \vert 4 x - 1 \vert + \frac{3}{4} \vert x + 1 \vert$$

and that the value of x that minimizes the loss function ƒ(x) is x=¼. FIG. 4 illustrates in graph 302, the functions F(x) (reference numerals 404 and 406) and ƒ(x) (reference numeral 408). When a gradient descent optimization algorithm is used to optimize the loss function, the algorithm receives stochastic sub-gradients

$$D ( x ) = 4 sign ( 4 x - 1 ) with a probability \frac{1}{4} , and$$

$$D ( x ) = sign ( x - 1 ) with a probability \frac{3}{4} .$$

Clipping these stochastic sub-gradients to magnitude 2 (i.e. γ=2), results in clipped gradients distributed as

$$\tilde{D} ( x ) = 2 sign ( 4 x - 1 ) with a probability \frac{1}{4} , and$$

$$\tilde{D} ( x ) = sign ( x + 1 ) with a probability \frac{3}{4} .$$

It is worth noting that the clipped gradients \tilde{D}(x) are identical to the stochastic sub-gradients of

$$\tilde{F} ( x ) = \frac{1}{2} \vert 4 x - 1 \vert with a probability \frac{1}{4} , and$$

$$\tilde{F} ( x ) = \vert x + 1 \vert with a probability \frac{3}{4} ,$$

corresponding to a different loss function

$$\tilde{f} ( x ) = \frac{1}{8} \vert 4 x - 1 \vert + \frac{3}{4} \vert x + 1 \vert$$

which is minimized for x=−1≠¼. Thus, any gradient based optimization algorithm receiving the clipped gradients \tilde{D}(x) converges towards x=−1, rather than the desired outcome of x=¼. This aliasing phenomenon is illustrated in graph 410 of FIG. 4 which shows the numerical value of x during optimization using a standard SGD optimizer that receives clipped gradients (indicated by reference numeral 412; reference numerals 418 and 420 respectively indicate

$$x = \frac{1}{4}$$

and x=−1). It can be seen that this method converges to x=−1. In contrast, when the loss function ƒ(x) is optimized using the described above process 200, this aliasing phenomenon does not occur and the numerical value of x converges towards x=¼ (indicated with reference numeral 414). Notably, the trajectory 414 closely resembles the trajectory 416 which indicates the numerical value of x during SGD optimization without gradient clipping. To generate the trajectories 412, 414, 416, x was initialized as x=2 (learning rate 0.01, 1500 iterations).

As noted above, in some implementations the one or more parameters may be parameters which define a neural network. In some implementations, the loss function indicates the performance of the neural network on a certain task.

With reference to FIG. 5, a particular form of the computer system 100 of FIG. 1 is described. In particular, the computer system 500 of FIG. 5 may be used to implement the above described process 200 to train a neural network 520 defined by one or more parameters 510. Similar to the computer system 100 described above, the computer system 500 of FIG. 5 is an example of a system, implemented as computer programs on one or more computers in one or more locations.

In broad terms, the computer system 500 trains the neural network 520 by finding values for the one or more parameters 510 that optimize a loss function (the loss function is a function of the one or more numerical parameters 510). More specifically, the computer system 500 may implement a gradient-based optimization method (e.g. a stochastic gradient descent method) that iteratively optimizes the loss function by generating, in each one of a plurality of training iterations, parameter updates for each of the numerical parameters 510. In the following, it is assumed, for simplicity, that the neural network 520 and the loss function are defined by more than one numerical parameter, i.e. by a plurality of parameters 510.

The neural network 520 may be trained by the method 200 to perform a computational task on an input data item, to generate a corresponding output data item. To this end, the computer system 500 comprises a training engine 540 to generate the parameter updates based on training data 530 processed by neural network 520. The training data 530 comprises a plurality of training items representative of the computational task. More specially, the training data 530 may comprise a plurality of training data input items 532 (representing possible input data items to the neural network 520) and, for each training data input item 532, an associated target data output item 534 (i.e. the desired corresponding result of performing the computational task on the training data input item 532).

Although the neural network 520 may take any form, the neural network 520 may be a feed-forward neural network having a sequence of layers which each (except the first) process an output of the preceding layer of the sequence. In some implementations the neural network 520 comprises a convolutional neural network, a neural network implementing at least one attention mechanism, etc.

The loss function is chosen based on the computational task the neural network is to perform. For example, it may be based on one or more target data output items 534 associated with one or more corresponding ones of the training data input items 532, and one or more corresponding output data items generated by the neural network 520 with the current parameters 510 upon receiving the corresponding one or more training data items 532 (i.e. the actual outputs of the neural network 520 upon receiving the training data items). The loss function may indicate the discrepancy between the target data output items 534 and the output data items.

The training engine 540 comprises a gradient engine 542, a clipping engine 544 and an optimization engine 546 which are implementations of the above described gradient engine 130, clipping engine 140 and optimization engine 150 of FIG. 1, respectively.

The gradient engine 542 is configured to, in each training iteration, determine a gradient of the loss function associated with the parameters 510 (i.e. to perform steps 204 and 212 of process 200). To this end, one or more training data input items 532 are selected from the training data 530, and processed, using the neural network 520, to generate one or more corresponding neural network outputs. The one or more corresponding neural network outputs and the one or more training data output items 534 associated with the one or more training data input items 532 are processed by the gradient engine to determine the gradient of the loss function associated with the at least one parameter of the neural network 520.

The gradient engine 542 may calculate the gradient by evaluating the loss function based on a selected sub-set of a plurality of training data items in the training data 530. In other words, the gradient engine 542 may calculate the gradient by performing a “mini-batching” method. The advantages of the computer system 500 may be most evident when less than 1000, less than 100 or even less than 10 training data items are selected and processed in each training iteration. The number of training data items may be small, for example, in situations in which the number of parameters is high, and the processing capacity of the computer device on which the system 500 is implemented is limited. This is particularly relevant for the distributed network implementations mentioned above.

The clipping engine 544 controls the size of the gradients used to generate the parameter updates as described above for the clipping engine 140. Thus, the clipping engine 544 is configured to process the gradient to generate a clipped gradient by: obtaining a clipped value for each of the parameters 510 generated in a previous training iteration, additively combining the gradient and the clipped value to generate a modified gradient, and processing, using the above described clipping function, the modified gradient to generate the clipped gradient. The clipping engine 544 also determines and stores at least one clipped value for use in the next training iteration.

Like the optimization engine 150, the optimization engine 546 processes the clipped gradient to generate the parameter update(s) for the parameters 510. As noted above, a (stochastic) gradient descent optimization algorithm may be used to generate the respective parameter update(s) from the clipped gradient.

As noted above, the training items are representative of the computational task. The training data items may, for example, consist of one of the following: image data items, encoding one or more still images; video data items, encoding a video sequence of images; audio data items, i.e. data representing sound (e.g. generated sound or sound received by a microphone); sensor data items, encoding the output of at least one sensor describing a state of an environment; or text data items encoding a sample of natural language text. When the trained neural network is in use and being used to perform the computational task, the input data items to the neural network are data items of the same sort (i.e. data items consisting of data in the same one of the five categories).

In certain cases, the training data items, and the input data items when the network is in use following training to perform the computational task, may comprise data items which comprise data in more than one of these categories (e.g. data items including both text data and associated image and/or video and/or sound data, such as text describing, or asking a question about, content of the image and/or video and/or sound data; or data items including associated image and/or video data and associated sound data, such as sounds encoding a voice describing, or asking a question about, content of the image and/or video data). Neural networks configured to receive input data items which comprise data in more than one format (e.g. more than one of the five categories listed above), that is “multi-modal inputs”, are referred to as “multi-modal networks”. In some implementations, the neural network 420 may be a multi-modal network.

The neural network 520 can be trained to perform classification type tasks. Thus, the output data item generated by the neural network 520 upon receiving one of the input data items 532 is data indicating that the input data item is in a specified one of a plurality of classes (e.g. pre-determined classes). The target data items 534 and output data items may, for example, be in the form of a one-hot vector. That is, a vector having a respective component for each class, and in which the element corresponding to the indicated class/selection is set to 1 and all other elements set to 0. The loss function may be based on a sum over the training data items of a dot-product between one-hot vectors representing the target data item and the output data item.

For example, where the training data item is image data (e.g. image data representing images of objects captured from the real-word, e.g. by a camera), the neural network 520 can be trained for objection classification, that is to predict or determine an object that is present in the image data. In another example, the task may be object detection, that is, to determine whether an aspect of the image data, such as a pixel or region, is part of an object. Another image-based task may be pose estimation of an object. The training data item may be a video data item (e.g. captured from the real-word by a camera). Possible video tasks include action recognition, that is, to determine what action is being performed in a video or a segment (aspect) of a video, and action detection to determine whether an action is being performed in a segment of video. The training data item may be an audio data item (e.g. recorded by a microphone). Possible audio tasks on audio data items include speech recognition and speaker recognition amongst others.

In the case of an image data item, which, as used here, includes a video data item, the tasks may include any sort of image processing or vision task such as an image classification or scene recognition task, an image segmentation task e.g. a semantic segmentation task, an object localization or detection task, a depth estimation task. When performing such a task the input may comprise or be derived from pixels of the image. For an image classification or scene recognition task the output may comprise a classification output providing a score for each of a plurality of image or scene categories e.g. representing an estimated likelihood that the input data item or an object or element of the input data item, or an action within a video data item, belongs to a category. For an image segmentation task the output may comprise, for each pixel, an assigned segmentation category or a probability that the pixel belongs to a segmentation category, e.g. to an object or action represented in the image or video. For an object localization or detection task the output may comprise data defining coordinates of a bounding box or region for one or more objects represented in the image. For a depth estimation task the output may comprise, for each pixel, an estimated depth value such that the output pixels define a (3D) depth map for the image. Such tasks may also contribute to higher level tasks e.g. object tracking across video frames; or gesture recognition i.e. recognition of gestures that are performed by entities depicted in a video.

Another example image processing task may include an image keypoint detection task in which the output comprises the coordinates of one or more image keypoints such as landmarks of an object represented in the image, e.g. a human pose estimation task in which the keypoints define the positions of body joints. A further example is an image similarity determination task, in which the output may comprise a value representing a similarity between two images, e.g. as part of an image search task.

The neural network 520 can be configured to receive any kind of digital data input (as the input data item) and to generate any kind of score, classification, or regression output based on the input.

For example, if the inputs to the neural network 520 are images or features that have been extracted from images, the output generated by the neural network 520 for a given image may be scores for each of a set of object categories, with each score representing an estimated likelihood that the image contains an image of an object belonging to the category.

As another example, if the inputs to the neural network 520 are Internet resources (e.g., web pages), documents, or portions of documents or features extracted from Internet resources, documents, or portions of documents, the output generated by the neural network for a given Internet resource, document, or portion of a document may be a score for each of a set of topics, with each score representing an estimated likelihood that the Internet resource, document, or document portion is about the topic.

As another example, if the inputs to the neural network 520 are features of an impression context for a particular advertisement, the output generated by the neural network may be a score that represents an estimated likelihood that the particular advertisement will be clicked on.

As another example, if the inputs to the neural network 520 are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, if the input to the neural network 520 is a sequence of text in one language, the output generated by the neural network may be a score for each of a set of pieces of text in another language, with each score representing an estimated likelihood that the piece of text in the other language is a proper translation of the input text into the other language.

As another example, if the input to the neural network 520 is an audio data item which is a sequence representing a spoken utterance, the output generated by the neural network may be a score for each of a set of pieces of text, each score representing an estimated likelihood that the piece of text is the correct transcript for the utterance. As another example, if the input to the neural network-based system is a sequence representing a spoken utterance, the output generated by the neural network 520 can indicate whether a particular word or phrase (“hotword”) was spoken in the utterance. As another example, if the input to the neural network 520 is a sequence representing a spoken utterance, the output generated by the neural network-based system can identify the natural language in which the utterance was spoken. Thus in general the network input may comprise audio data for performing an audio processing task and the network output may provide a result of the audio processing task e.g. to identify a word or phrase or to convert the audio to text.

As another example, the task can be a health prediction task, where the input is a sequence derived from patient sequence data for a patient and the output is a prediction that is relevant to the future health of the patient, e.g., a predicted treatment that should be prescribed to the patient, the likelihood that an adverse health event will occur to the patient, or a predicted diagnosis for the patient.

In another example, the output data items may be data for controlling an agent, e.g. in a reinforcement learning system. The input data items are “observations” of the state of an environment. The output data items may comprise data indicative of an action to be performed by the agent or a selection of a policy from which actions to be performed by the agent are selected. The reinforcement learning system may proceed to select an action and the agent may proceed to carry out the action.

In implementations, the observation may relate to a real-world environment and the selected action relates to an action to be performed by a mechanical agent, such as an electromechanical agent (e.g. a robot), which moves (by translation and/or by reconfiguration of the agent) within the environment. The agent may interact with the environment to accomplish a task, e.g. a robot manipulating objects in the environment, or an autonomous or semi-autonomous land or air or water vehicle navigating through the environment. In another example, the agent may be a control system for an industrial facility.

The input data items may be a sequence of observations or other data characterizing states of an environment, e.g. a video sequence, and the output data items defines an action to be performed by the agent in response to the most recent input data item in the sequence.

At each time step, the state of the environment at the time step depends on the state of the environment at the previous time step and the action performed by the agent at the previous time step.

In general, the observations (input data items) may include, for example, one or more of images, object position data, and sensor data to capture observations as the agent interacts with the environment, for example sensor data from an image, distance, or position sensor or from an actuator. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. For example, in the case of a robot the observations may include data characterizing the current state of the robot, e.g. one or more of: joint position, joint velocity, joint force, torque or acceleration, and global or relative pose of a part of the robot such as an arm and/or of an item held by the robot. The observations may also include, for example, sensed electronic signals such as motor current or a temperature signal; and/or image or video data for example from a camera or a LIDAR sensor, e.g., data from sensors of the agent or data from sensors that are located separately from the agent in the environment. As used herein an image includes a point cloud image e.g. from a LIDAR sensor.

The actions may comprise control inputs to control a physical behavior of the mechanical agent e.g. robot, e.g., torques for the joints of the robot or higher-level control commands; or to control the autonomous or semi-autonomous land or air or sea vehicle, e.g., torques to the control surface or other control elements of the vehicle or higher-level control commands. In other words, the actions can include for example, position, velocity, or force/torque/acceleration data for one or more joints of a robot or parts of another mechanical agent. Action data may include data for these actions and/or electronic control data such as motor control data, or more generally data for controlling one or more electronic devices within the environment the control of which has an effect on the observed state of the environment. For example, in the case of an autonomous or semi-autonomous land or air or sea vehicle the actions may include actions to control navigation e.g. steering, and movement e.g. braking and/or acceleration of the vehicle.

In such applications the task-related rewards may include a reward for approaching or achieving one or more target locations, one or more target poses, or one or more other target configurations, e.g. to reward a robot arm for reaching a position or pose and/or for constraining movement of a robot arm. A cost may be associated with collision of a part of a mechanical agent with an entity such as an object or wall or barrier. In general, a reward or cost may be dependent upon any of the previously mentioned observations e.g. robot or vehicle positions or poses. For example, in the case of a robot a reward or cost may depend on a joint orientation (angle) or speed/velocity e.g. to limit motion speed, an end-effector position, a center-of-mass position, or the positions and/or orientations of groups of body parts; or may be associated with force applied by an actuator or end-effector, e.g. dependent upon a threshold or maximum applied force when interacting with an object; or with a torque applied by a part of a mechanical agent. In another example a rewards or cost may depend on energy or power usage, motion speed, or a position of e.g. a robot, robot part or vehicle.

The output data may be for selecting an option for controlling an agent in a reinforcement learning system, wherein the selected option comprises a sequence of primitive actions performed by the agent under control of a respective option policy neural network. A primitive action may be an action performed by the agent at a time step. In implementations a manager neural network selects from options (or primitive actions) to perform a task. Training the neural network-based system may result in fine-tuning a set of pre-trained skills for particular tasks. Further details relating to skills in a reinforcement learning systems and learning of skills can be found in Eysenbach et al., “Diversity is all you need: learning skills without a reward function”, arXiv:1802.06070, available at: https://arxiv.org/abs/1802.06070 which is hereby incorporated by reference in its entirety.

In the above described applications the same observations, actions, rewards and costs may be applied to a simulation of the agent in a simulation of the real-world environment. Once the system has been trained in the simulation, e.g. once the neural networks of the system/method have been trained, the system/method be used to control the real-world agent in the real-world environment. That is, control signals generated by the system/method may be used to control the real-world agent to perform a task in the real-world environment in response to observations from the real-world environment. Optionally the system/method may continue training in the real-world environment.

In some applications the environment is a networked system and the actions comprise configuring settings of the networked system that affect the energy efficiency or performance of the networked system. The networked system may be e.g. an electric grid or a data center.

In some applications the agent may be a static or mobile software agent i.e. a computer programs configured to operate autonomously and/or with other software agents or people to perform a task. For example, the environment may be a circuit or an integrated circuit routing environment and the agent may be configured to perform a routing task for routing interconnection lines of a circuit or of an integrated circuit e.g. an ASIC. The reward(s) and/or cost(s) may then be dependent on one or more routing metrics such as interconnect length, resistance, capacitance, impedance, loss, speed or propagation delay; and/or physical line parameters such as width, thickness or geometry, and design rules; or may relate to a global property such as operating speed, power consumption, material usage, cooling requirement, or level of electromagnetic emissions. The observations may be e.g. observations of component positions and interconnections; the actions may comprise component placing actions e.g. to define a component position or orientation and/or interconnect routing actions e.g. interconnect selection and/or placement actions.

In some applications the agent may be an electronic agent and the observations may include data from one or more sensors monitoring part of a plant or service facility such as current, voltage, power, temperature and other sensors and/or electronic signals representing the functioning of electronic and/or mechanical items of equipment. The agent may control actions in a real-world environment including items of equipment, for example in a facility such as: a data center, server farm, or grid mains power or water distribution system, or in a manufacturing plant or service facility. The observations may then relate to operation of the plant or facility, e.g. they may include observations of power or water usage by equipment, or observations of power generation or distribution control, or observations of usage of a resource or of waste production. The actions may include actions controlling or imposing operating conditions on items of equipment of the plant/facility, and/or actions that result in changes to settings in the operation of the plant/facility e.g. to adjust or turn on/off components of the plant/facility. The reward(s) and/or cost(s) may include one or more of: a measure of efficiency, e.g. resource usage; a measure of the environmental impact of operations in the environment, e.g. waste output; electrical or other power or energy consumption; heating/cooling requirements; resource use in the facility e.g. water use; or a temperature of the facility or of an item of equipment in the facility.

In some applications the environment may be a data packet communications network environment, and the agent may comprise a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The reward(s) or cost(s) may be defined in relation to one or more of the routing metrics i.e. to maximize or constrain one or more of the routing metrics.

In some other applications the agent is a software agent which manages distribution of tasks across computing resources e.g. on a mobile device and/or in a data center. In these implementations, the observations may include observations of computing resources such as compute and/or memory capacity, or Internet-accessible resources; and the actions may include assigning tasks to particular computing resources. The reward(s) or cost(s) may be to maximize or limit one or more of: utilization of computing resources, electrical power, bandwidth, and computation speed.

In some other applications the environment may be an in silico drug design environment, e.g. a molecular docking environment, and the agent may be a computer system for determining elements or a chemical structure of the drug. The drug may be a small molecule or biologic drug. An observation may be an observation of a simulated combination of the drug and a target of the drug. An action may be an action to modify the relative position, pose or conformation of the drug and drug target (or this may be performed automatically) and/or an action to modify a chemical composition of the drug and/or to select a candidate drug from a library of candidates. One or more rewards or costs may be defined based on one or more of: a measure of an interaction between the drug and the drug target e.g. of a fit or binding between the drug and the drug target; an estimated potency of the drug; an estimated selectivity of the drug; an estimated toxicity of the drug; an estimated pharmacokinetic characteristic of the drug; an estimated bioavailability of the drug; an estimated ease of synthesis of the drug; and one or more fundamental chemical properties of the drug. A measure of interaction between the drug and drug target may depend on e.g. a protein-ligand bonding, van der Waal interactions, electrostatic interactions, and/or a contact surface region or energy; it may comprise e.g. a docking score.

In some other applications the environment is an Internet or mobile communications environment and the agent is a software agent which manages a personalized recommendation for a user. The observations may comprise previous actions taken by the user, e.g. features characterizing these; the actions may include actions recommending items such as content items to a user. The reward(s) or cost(s) may be to maximize or constrain one or more of: an estimated likelihood that the user will respond favorably to being recommended the (content) item, a suitability unsuitability of one or more recommended items, a cost of the recommended item(s), and a number of recommendations received by the user, optionally within a time span.

In another example, the updates to the parameters of the neural network are performed jointly with (i.e. substantially simultaneously with or interleaved with) updates to second parameters which define a second neural network. The joint updates constitute an adversarial learning method in an adversarial model including the neural network and the second neural network. The training is performed to minimize an objective function having a plurality of loss function components, at least one of the loss function components being a function of both the parameters and the second parameters, where optimizing one of the loss function components with respect to the numerical parameters moves another of the loss function components away from its optimal value.

The adversarial model may be any type of adversarial model. In particular, it may be selected from the group including generative adversarial networks (GANs), proximal gradient TD learning, multi-level optimization (Pfau and Vinyals, 2016), synthetic gradients (Jaderberg et al, 2017), hierarchical reinforcement learning (Wayne and Abbot, 2014; Vezhnevets et al, 2017), curiosity networks (as proposed by Pathak et al 2017), and imaginative networks (as proposed by Racaniere et al, 2017). Typically, these adversarial models contain a plurality of neural networks and they are trained by an objective function which causes these networks to compete against each other. The training is typically designed to reach the Nash equilibrium for this competition. Input data items to at least one of the neural networks of the adversarial network may be data obtained from the real world (e.g. sensor data from a sensor such as a camera or video camera, or sound captured by a microphone) or samples of natural language (e.g. in written form). Alternatively or additionally, outputs from at least one of the neural networks may be data (e.g. image data, video data and/or sound data) which mimics data obtained from the real world. Similarly, outputs from at least one of the neural networks of the adversarial network may be control data to influence the real world (e.g. to control at least one agent in the real world such as an electromechanical agent moving (by translation and/or change of configuration) in the real world), and/or images and/or sound data, or samples of natural language (e.g. in written form). For example, one of the neural networks may be configured to generate output data which mimics data obtained from the real world (e.g. conditioned on input data; for example, one which produces a sound signal based on a received string of symbols (e.g. reads out a text composed of letters and/or phonemes), or produces a still or moving image based on received string of symbols (e.g. an image described by text), and/or which is control data, and the other of the neural networks may be configured to process the output data of the other neural network, to generate a classification or score for that output data.

Note that although adversarial networks are provided above as an example, training the neural network 510 to generate output data which encodes a sound signal (e.g. conditioned on a received string of symbols), or produce a still or moving image (e.g. conditioned based on a received string of symbols), and/or which is control data, is not limited to the case that the neural network 510 is trained by adversarial learning. It may instead be a neural network trained by any other technique (e.g. contrastive learning, reinforcement learning, imitation learning, etc.) which employs a loss function.

In some implementations, the system 500 may train the neural network 520 using a full-batch method (i.e. the entire training data 530 is processed in steps 204 and 212 of process 200) or a mini-batch method (i.e. a subset of the training data 530 is processed in steps 204 and 212 of process 200). In other implementations, the system 500 may train the neural network 520 using an online learning method. In this case, the training items of the training data 530 may sequentially become available to the system 500 (e.g. the training items may be received from an incoming stream of training data items (e.g. a video stream, stream of text data, and the like) or the training items for a particular training iteration may be generated in said training iteration based on the values of the plurality of numerical parameters). Older data items may become un-representative of the task the neural network has to perform, i.e. the distribution of training data items may change over time, and the online learning, being based on the most recent training items adapts to these changes (e.g. in an scenario in which multiple neural networks are trained together, such as an adversarial learning scenario discussed below, as each neural network changes, the task the other neural network(s) have to perform changes also). In general, in online learning, the number of (newly received) training data items available for processing in each training iteration may be small (e.g. less than 8 training data items, less than 5 training data items or only a single training data item may be processed in each training iteration). In such an online learning setting, each training data item in the training dataset may be presented only once (or a limited number of times) to the neural network 520 and the training engine 540.

A method of performing the computational task may be implemented using the neural network 520 trained using the training method 200 described above, e.g. a method of classifying input data items or of controlling an agent of the type described above, e.g. to move in and/or interact with in a real-world environment.

The training performances for two example neural networks trained using the system 500 of FIG. 5 have been experimentally investigated. The first example neural network is a small convolutional neural network configured to perform an image classification task (i.e. to classify input image data into one of a plurality of classes). In particular, this neural network has two convolutional layers with 32 and 64 features respectively, initialized with the LeCun normal initialization (also known as the truncated normal initialization) with an initial bias of zero. Each convolutional layer has a 3×3 kernel and followed by average pooling over a 2×2 window with 2×2 strides. The convolution layers are fully connected layers with features of width 250, 250, 10 (initialized with Gaussian Glorot initialization and initial bias of 0.01). All of the activations are ReLU. The example neural network is trained using the CIFAR-10 dataset (which comprises a plurality of images that are labelled with one of 10 mutually exclusive classes) according to the above described process 200.

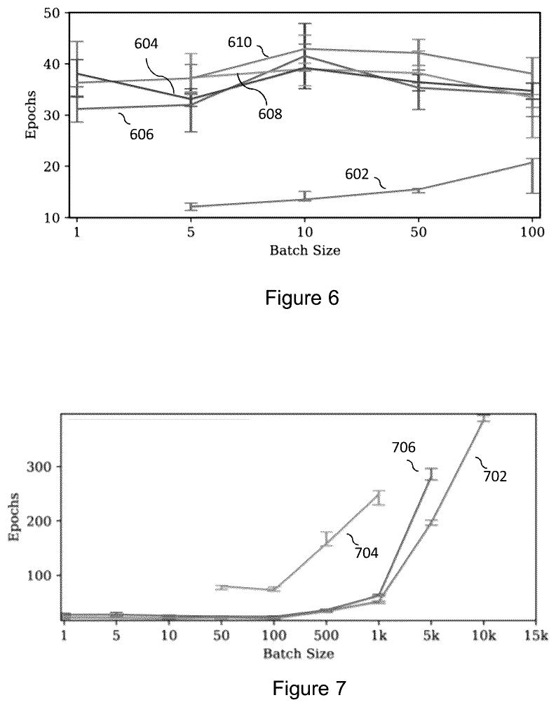

FIGS. 6 and 7 illustrate the training performance of the first example neural network. In particular, FIGS. 6 and 7 show the median number of epochs needed to reach 99% training accuracy over 5 seeds for different training batch sizes. The data points shown in FIG. 6 are obtained by using (as the optimization algorithm in steps 208 and 220 of the training process 200) the “Adam” algorithm (parameters β₁=0.90 and β₂=0.999). The learning rate is tuned to the batch size according to the median (smaller is better) across 5 log-spaced values. For the data shown in FIG. 6, the threshold value γ=0.5 is kept constant during training.

In FIG. 6, the reference numerals 604 and 602 respectively indicate data points obtained using a component-based or norm-based clipping function in steps 206 and 218 of the training process 200. It can be seen that, for norm-based clipping (602), the training performance of the example neural network is improved over the comparative examples 606, 608, 610 (reference numeral 606: no gradient clipping; reference numeral 608: component-wise gradient clipping without storing and reapplying the clipped values in subsequent iterations; reference numeral 610: norm-based gradient clipping without storing and reapplying the clipped values in subsequent iterations). Specifically, the number of epochs required for convergence by the example of the present disclosure 602 that uses norm-based clipping is significantly lower than for the comparative examples 606, 608, 610. This improvement is likely to be due to a smoothing out of gradient noise due to the memory of the clipped values.

FIG. 7 illustrates the training performance of the first example neural network (indicated with the reference numeral 702) when component-wise clipping is used and the threshold value γ is adapted during training iterations of process 200 (parameters: a=10, b=0). The data points shown in FIG. 7 are obtained by using (as the optimization algorithm in steps 208 and 220 of the training process 200) the standard stochastic gradient decent (SGD) algorithm. It can be seen that the training performance of the example neural network 702 is improved over the comparative examples 704, 706 (reference numeral 704: adaptive gradient clipping without storing and reapplying the clipped values in subsequent iterations; reference numeral 706: no gradient clipping). Specifically, the number of epochs required for convergence by the SGD method without gradient clipping 704 is always much higher than for SGD with adaptive gradient clipping 706 or the example of the present disclosure 702. For a batch size of over 100 examples, the number of training epochs required for convergence by SGD without gradient clipping 704 rises dramatically. SGD with clipping 706 also exhibits a dramatic increase in the number of epochs required for a batch size above 1,000, whereas the example of the present disclosure 702 requires a number of epochs which rises more slowly with the batch size.

The second example neural network trained according to the above described process 200 is a language modelling network, in particular a decoder-only transformer network (the clipping threshold value γ is adapted during training iterations of process 200, as described above). In particular, this neural network is trained using online (prequential) learning, i.e. the training dataset is read in sequentially. More specifically, the second example neural network reads in a sequence of 16 tokens in each training iteration (with a learning rate of 0.0001; a low value was found to enhance stability of the method).

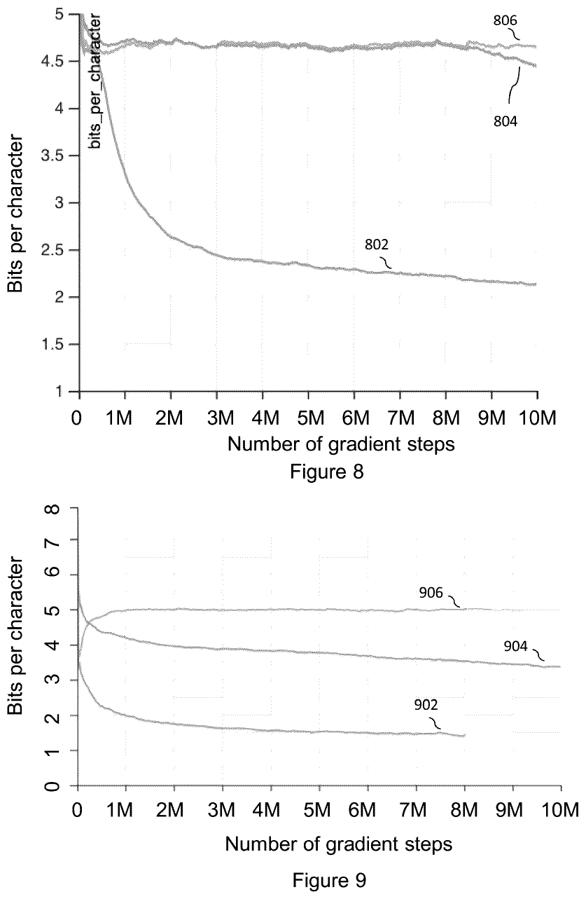

FIG. 8 is a graph illustrating the training performance of the second example neural network 802 when trained using the Enwik8 dataset (which comprises a 100 million bytes of Wikipedia text). In particular, FIG. 8 shows the “bits per character” (bpc) (as a measure of the performance of the second example neural network; lower values of bpc indicate a better performance) over the course of 10 million training iterations. It can be seen that the bpc value 802 for the second example neural network rapidly decreases over the first few million training iterations and further decreases (at a slower rate) until the training is completed. In comparison, the bpc values remain high throughout the training for a comparable network trained using SGD without clipping (reference numeral 804) or Adam optimization with conventional norm-clipping (reference numeral 806; clipping threshold of 1). Thus, the second example neural network exhibits a training performance which significantly improved over the comparative examples.

FIG. 9 is a graph illustrating the training performance of the second example neural network 902 when trained using the MassiveWeb dataset (which comprises about 10.5 terabyte of text). It can be seen that (similar to FIG. 8) the bpc value of the second example neural network 902 rapidly decreases during the initial phase of the training and keeps decreasing throughout the training. In particular, the second example neural network achieves lower bpc values than the comparative examples 904, 906 (reference numeral 904: SGD without clipping, reference numeral 906: Adam with conventional norm-clipping, clipping threshold of 1). Thus, the improved and stable training shown in FIGS. 8 and 9 illustrates that the process 200 is well-suited for rapid online learning. In implementations, one or more computer storage media may store instructions that when executed by one or more computers cause the one or more computers to perform the operations of the process 200 described above.

In implementations, a system may comprise one or more computers and one or more storage devices communicatively coupled to the one or more computers. The one or more storage devices may store instructions that, when executed by the one or more computers, cause the one or more computers to perform operations of the process 200 described above.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of optimizing a loss function defined by a one or more numerical parameters, the method comprising:
determining initial values of the one or more parameters; and
performing a plurality of training iterations, each training iteration comprising:
determining a gradient of the loss function associated with the one or more parameters;
obtaining a clipped value generated in a previous training iteration;
additively combining the gradient and the clipped value to generate a modified gradient;
processing, using a clipping function based on a threshold value, the modified gradient to generate a clipped gradient;
updating the value of the one or more parameters based on the clipped gradient; and
storing, as the clipped value for use in a next training iteration, a difference between the modified gradient and the clipped gradient,
wherein one or more of the iterations further comprise adapting the threshold value based on an average value of gradients of previous iterations.

2. The method of claim 1, further comprising performing, prior to the plurality of iterations, a first training iteration comprising:
determining an initial gradient of the loss function;
generating a clipped gradient by processing the initial gradient using the clipping function,
updating the value of the one or more parameters based on the clipped gradient; and
storing, as the clipped value for use in a first of the plurality of iterations, a difference between the gradient and the clipped gradient.

3. The method of claim 1, wherein the loss function is defined by a plurality of parameters and the gradient comprises a corresponding element for each of the plurality of parameters, and wherein said processing the modified gradient to generate a clipped gradient comprises applying the clipping function element-wise to the modified gradient such that an absolute value of each element of the clipped gradient is equal or below a threshold value.

4. The method of claim 1, wherein the loss function is defined by a plurality of parameters and the gradient comprises a corresponding element for each of the plurality of parameters, and wherein said processing the modified gradient to generate a clipped gradient comprises applying the clipping function element-wise to the modified gradient such that an absolute value of each element of the clipped gradient has an absolute value equal to a threshold value and a sign which is the same as the corresponding element of the modified gradient.

5. The method of claim 1, wherein said adapting the threshold value is further based on a variance of values of the gradients of the previous iterations.

6. The method of claim 1, wherein the loss function is defined by a plurality of parameters and the gradient comprises a corresponding element for each of the plurality of parameters, and wherein said processing the modified gradient to generate a clipped gradient comprises:
calculating a Euclidean norm of the modified gradient; and
if the Euclidean norm is larger than the threshold value, generating the clipped gradient by normalizing the modified gradient such that the Euclidean norm of the clipped gradient equals the threshold value, or
if the Euclidean norm is not larger than the threshold value, providing, as the clipped gradient, the modified gradient.

7. The method of claim 1, wherein said updating the value of the one or more parameters based on the clipped gradient comprises using a gradient descent optimization algorithm to update the value of the one or more parameters based upon the clipped gradient.

8. The method of claim 7, wherein the gradient descent optimization algorithm is a stochastic gradient descent algorithm.

9. The method of claim 1 in which the one or more parameters are parameters defining a neural network, and said determining a gradient of the loss function associated with the one or more parameters comprises:
obtaining a plurality of training data items representative of a task;
selecting one or more training data items from the plurality of training data items;
processing the one or more training data items using the neural network to generate one or more corresponding neural network outputs, and generating a loss function based on the one or more network outputs; and
determining the gradient of the loss function associated with the one or more parameters of the neural network.

10. The method of claim 9, wherein the neural network comprises a convolutional neural network.

11. The method of claim 9, wherein less than 100 training data items are selected and processed in each training iteration.

12. The method of claim 9, in which the neural network is configured to generate a control action for controlling a mechanical or electrical agent interacting with a real-world environment.

13. The method of claim 9, in which the neural network is configured to receive a network input which is an image or a sound signal, or features derived from an image or sound signal, and the network output is a classification or the image or sound signal, or in which the neural network is configured to generate data which is an image or sound signal.

14. The method of claim 1, wherein the method is performed using a distributed network comprising a plurality of computing systems, and said determining a gradient of the loss function associated with the one or more parameters comprises determining, by each of the computing devices, a respective gradient of the loss function associated with the one or more parameters.

15. The method of claim 14, wherein:
said obtaining a clipped value generated in a previous training iteration comprises obtaining, by each of the computing systems, a respective clipped value generated in a previous training iteration;
said additively combining the gradient and the clipped value comprises each of the computing systems additively combining the respective gradient and the respective clipped value to generate a respective modified gradient;
said processing the modified gradient to generate a clipped gradient comprises processing, by each of the computing systems, using the clipping function, the respective modified gradient to generate a respective clipped gradient;
said updating the value of the one or more parameters based on the clipped gradient comprises aggregating the clipped gradients generated by the plurality of computing systems to generate an aggregated clipped gradient and updating the value of the one or more parameters based on the aggregated clipped gradient; and
said storing a clipped value comprises storing, by each of the computing systems, as the respective clipped value for use in a next training iteration, a difference between the respective modified gradient and the respective clipped gradient.

16. The method of claim 14, wherein said additively combining the gradient and the clipped value comprises aggregating the respective gradients generated by the plurality of computing systems to generate an aggregated gradient and additively combining the aggregated gradient and the clipped value to generate a modified gradient.

17. One or more computer storage media storing instructions that when executed by one or more computers cause the one or more computers to perform operations for optimizing a loss function defined by a one or more numerical parameters, the operations comprising:
determining initial values of the one or more parameters; and
performing a plurality of training iterations, each training iteration comprising:
determining a gradient of the loss function associated with the one or more parameters;
obtaining a clipped value generated in a previous training iteration;
additively combining the gradient and the clipped value to generate a modified gradient;
processing, using a clipping function based on a threshold value, the modified gradient to generate a clipped gradient;
updating the value of the one or more parameters based on the clipped gradient; and
storing, as the clipped value for use in a next training iteration, a difference between the modified gradient and the clipped gradient,
wherein one or more of the iterations further comprise adapting the threshold value based on an average value of gradients of previous iterations.

18. A system comprising:
one or more computers; and
one or more storage devices communicatively coupled to the one or more computers, wherein the one or more storage devices store instructions that, when executed by the one or more computers, cause the one or more computers to perform operations for optimizing a loss function defined by a one or more numerical parameters, the operations comprising:
determining initial values of the one or more parameters; and
performing a plurality of training iterations, each training iteration comprising:
determining a gradient of the loss function associated with the one or more parameters;
obtaining a clipped value generated in a previous training iteration;
additively combining the gradient and the clipped value to generate a modified gradient;
processing, using a clipping function based on a threshold value, the modified gradient to generate a clipped gradient;
updating the value of the one or more parameters based on the clipped gradient; and
storing, as the clipped value for use in a next training iteration, a difference between the modified gradient and the clipped gradient,
wherein one or more of the iterations further comprise adapting the threshold value based on an average value of gradients of previous iterations.

19. The system of claim 18, further comprising performing, prior to the plurality of iterations, a first training iteration comprising:
determining an initial gradient of the loss function;
generating a clipped gradient by processing the initial gradient using the clipping function,
updating the value of the one or more parameters based on the clipped gradient; and
storing, as the clipped value for use in a first of the plurality of iterations, a difference between the gradient and the clipped gradient.

20. The system of claim 18, wherein the loss function is defined by a plurality of parameters and the gradient comprises a corresponding element for each of the plurality of parameters, and wherein said processing the modified gradient to generate a clipped gradient comprises applying the clipping function element-wise to the modified gradient such that an absolute value of each element of the clipped gradient is equal or below a threshold value.
